(19) United States
(12) Patent Application Publication
(10) Pub. No.: US 2010/0142668 A1
(43) Pub. Date: Jun. 10, 2010

(54) POROUS PLENUM SPACER FOR DUAL-COOLED FUEL ROD

(75) Inventors: Young Ho Lee, Daejeon (KR); Kang Hee Lee, Daejeon (KR); Jae Yong Kim, Daejeon (KR); Kyung Ho Yoon, Daejeon (KR); Hyung Kyu Kim, Daejeon (KR); Chang Hwan Shin, Daejeon (KR); Dong Seok Oh, Daejeon (KR); Wang Ki In, Daejeon (KR); Tae Hyun Chun, Daejeon (KR); Kun Woo Song, Daejeon (KR)

Correspondence Address: MAIER & MAIER, PLLC, 1000 DUKE STREET, ALEXANDRIA, VA, 22314, US

(73) Assignees: Korea Atomic Energy Research Institute, Daejeon (KR); Korea Hydro and Nuclear Power Co., Ltd., Seoul (KR)

(21) Appl. No.: 12/630,901

(22) Filed: Dec. 4, 2009

(30) Foreign Application Priority Data
Dec. 8, 2008 (KR) 10-2008-0123767

(51) Int. Cl. G21C 3/04

(52) U.S. Cl. 376/412

(57) ABSTRACT

A porous plenum spacer is inserted into the plenum of a dual-cooled fuel rod having concentric inner and outer cladding tubes. The porous plenum spacer includes a hollow cylindrical body inserted into the annular space between the inner and outer cladding tubes. The hollow cylindrical body includes a plurality of through-holes formed in an outer circumference thereof or at least one groove formed in one of outer and inner circumferences thereof in a lengthwise direction. Pores formed by the through-holes or the grooves of the hollow cylindrical body of the porous plenum spacer are allowed to secure a space containing fission gas inevitably generated by a nuclear reaction.

### BACKGROUND OF THE INVENTION

1. Field of the Invention

The present invention relates, in general, to a spacer inserted into the plenum of a dual-cooled fuel rod having concentric inner and outer cladding tubes and, more particularly, to a porous plenum spacer for a dual-cooled fuel rod, which includes a hollow cylindrical body inserted into an annular space between the inner and outer cladding tubes and is characterized in that the hollow cylindrical body includes either a plurality of through-holes formed in an outer circumference thereof or at least one groove formed in one of outer and inner circumferences thereof in a lengthwise direction. Pores formed by the through-holes or grooves of the hollow cylindrical body of the porous plenum spacer are allowed to secure a space containing fission gas inevitably generated by nuclear reaction.

2. Description of the Related Art

A nuclear fuel assembly is charged in the core of a pressurized water reactor. This nuclear fuel assembly is composed of a plurality of fuel rods, into each of which a cylindrical uranium sintered compact (or a cylindrical uranium pellet) is inserted.

The fuel rods can be divided into two types, cylindrical and annular, according to shape. The annular fuel rods are called dual-cooled fuel rods.

In comparison with the pellet of the cylindrical fuel rod, the pellet of the annular fuel rod, i.e. the dual-cooled fuel rod, has a low internal temperature due to a thinner thickness and a wider heat transfer area, and thus a relatively higher safety margin.

FIG. 1 is a schematic front view illustrating a conventional cylindrical nuclear fuel assembly.

Referring to FIG. 1, the nuclear fuel assembly 100 includes fuel rods 101, spacer grids 105, guide thimbles 103, an upper end fitting 107 and a lower end fitting 106.

Each fuel rod 101 has a structure in which a uranium sintered compact or a uranium pellet (not shown) generating high-temperature heat through nuclear fission is enclosed by a zirconium alloy cladding tube.

Each fuel rod 101 has upper and lower end plugs 108 and 109 coupled to upper and lower portions thereof so as to prevent inert gas filled between the cladding tubes thereof from leaking out.

The inner upper portion of the fuel rod in which a uranium pellet, nuclear fuel, is charged, has an empty space, which is called a plenum. The plenum serves to contain fission gas inevitably generated by an ongoing nuclear reaction, and has a plenum spring located therein to maintain the pellet in the fuel rod at a predetermined position.

In a 12×12 dual-cooled fuel rod proposed for structural compatibility with the core of an existing pressurized water reactor, the annular pellet charged into the dual-cooled fuel rod must have the same position and height as existing cylindrical nuclear fuel rods, and thus the plenum must assume the same position as in existing cylindrical nuclear fuel rods. Here, the plenum spring inserted into the plenum inevitably is of a greater diameter than that of the existing fuel rod due to the diameter of the dual-cooled fuel rod being increased. This is also because the spring applicable to the interior of the dual tube structure has no alternative but to be restricted to a coil spring. Consequently, the diameter of the inserted plenum spring is determined depending on the diameters of the outer and inner cladding tubes.

FIGS. 2A and 2B illustrate the cross section of a plenum spring applied to interiors of existing and dual-cooled fuel rods. As illustrated in FIG. 2B, in the plenum spring applied to the dual-cooled fuel rod, the middle between an inner surface of an outer cladding tube and an outer surface of an inner cladding tube may be regarded as the diameter D of the plenum spring, and the plenum spring must not buckle so that contact with the fuel rod is reliably prevented. Meanwhile, according to design criteria of the fuel rod, rigidity of the plenum spring should be more than six times the weight of the charged nuclear fuel. Thus, it is necessary to review the dual-cooled fuel rod by equally applying this criterion to the dual-cooled fuel rod.

The plenum spring in the existing fuel rod illustrated in FIG. 2A has the following characteristics.

First, nuclear fuel has a density of 10.5 g/cm³ and a volume of π×dₚₑₗₗₑₜ²×H (active length), and thus the weight of a pellet is calculated as being about 2.11 kg. When this weight is calculated in terms of force, the force is 20.7 N. Further, elastic deformation of the plenum spring is simply calculated from the following formula (1).

F=K×X (1)

where F is the load, K is the spring constant, and X is the amount of spring deformation. Calculating the load F using the spring constant K and the spring deformation displacement obtained from the characteristic values of the plenum for the existing commercial nuclear fuel, F=4.5595 N/mm×32.4 mm=147.7 N. This value amounts to 7.14 times the weight of the pellet in the fuel rod.

Meanwhile, the spring constant K used in the existing commercial nuclear fuel may be determined by the following formula (2).

$$K = \frac{G \cdot {d}^{4}}{8 \cdot {D}^{3} \cdot N} \qquad ( 2 )$$

where G is the shear modulus, d is the diameter of the spring wire, D is the average diameter of the spring, and N is the effective number of the spring coils. In the case of Inconel X750, it is difficult to obtain an accurate value of the shear modulus, but it is known that the shear modulus is about 70 GPa. Calculating the spring constant K by inputting dimensions of the plenum spring for the existing nuclear fuel, the spring constant K is about 4.613 N/mm, which is similar to the value (4.5595 N/mm) applied to the calculation of formula (1).

If the plenum spring of the dual-cooled fuel rod has the same free length as that of the existing cylindrical fuel rod, the plenum spring of the dual-cooled fuel rod, in which the average diameter is increased, must be compressed by 32.4 mm, and a force required for this compression must be more than at least six times (6 G) the weight of the charged pellet. Assuming that the force required for the deformation of the plenum spring is 7 G of the weight of the charged pellet, the spring constant K obtained by calculation is about 7.23 N/mm. For reference, an amount of the annular pellet for the dual-cooled fuel rod is predicted to be 3.413 kg. On the basis of the value, 7 G is 234.13 N. In this manner, the relatively high value of the spring constant K serves to increase the load acting on the end plug by about 60%, compared to the spring constant K of the existing fuel rod. As a result, it is essential to perform the estimation of soundness as well as the optimization of a welding method on welding zones of the end plugs welded to opposite ends of the fuel rod.

Taking the average diameter D of the plenum spring into consideration to apply it to the dual-cooled fuel rod illustrated in FIG. 2B, the average diameter D can be regarded as the diameter of a horizontal circular cross section cutting through the middle of an annular space between the inner and outer cladding tubes. Thus, it can be easily found that the average diameter D is 12.45 mm. Since the diameter d of the spring wire and the effective number N of the spring coils are variables in the formula (2), the relation between them must be checked. Meanwhile, a maximum value dₘₐₓ, of the diameter d of the spring wire of the plenum spring inserted into the dual-cooled fuel rod may be limited to a thickness of the pellet.

0<d≦dₘₐₓ and dₘₐₓ=2.307 mm (3)

The relation between N and d is given from this result in formula (4).

$$N = \frac{G}{8 \cdot {D}^{3} \cdot K} \cdot {d}^{4} = 0.63 \cdot {d}^{4} [ unit of d \text{:} mm ] \qquad ( 4 )$$

If the diameter d of the spring wire is 1.448 mm as in the existing plenum spring, the effective number N of the spring coils is 2.77 which is a very small value. Further, if the allowable maximum diameter dₘₐₓ is 1.7 mm, the effective number N of the spring coils is 5.26 (in the case where a gap between the inner/outer cladding tube and the plenum spring is set to 0.3 mm similarly to the existing case). When the diameter d of the spring wire is constant, the spring constant K is in inverse proportion to the cubed average radius of the spring. For this reason, the spring constant K and the shear modulus G as the property of the material must be varied in the dimensional conditions of the present dual-cooled fuel rod (i.e. on which the average diameter of the spring cannot be greatly varied from 12.45 mm). However, the variation is very small. In detail, since the plenum spring for the dual-cooled fuel rod in which the effective number of the spring coils is five, cannot perform the normal function of the spring when it has the same length as that of the existing fuel rod, the length of the plenum spring must be shortened (see FIGS. 3 and 4). Thus, to fix a position of the pellet for the dual-cooled fuel rod using the shortened plenum spring, the length of a spacer inserted to prevent direct contact with the pellet must be lengthened. However, when a structure of the conventional spacer is maintained without change, the plenum is not secured.

### SUMMARY OF THE INVENTION

Accordingly, the present invention has been made keeping in mind the above problems occurring in the related art, and embodiments of the present invention provide a porous plenum spacer for a dual-cooled fuel rod, capable of sufficiently securing a plenum containing fission gas inevitably generated by an ongoing nuclear reaction even when the length of a spacer is lengthened due to reduction of the length of a plenum spring used for the dual-cooled fuel rod.

According to an aspect of the present invention, there is provided a porous plenum spacer for a dual-cooled fuel rod, in which the porous plenum spacer is inserted into a plenum of the dual-cooled fuel rod having concentric inner and outer cladding tubes. The porous plenum spacer comprises: a hollow cylindrical body inserted into an annular space between the inner and outer cladding tubes; and a plurality of through-holes formed in an outer circumference of the hollow cylindrical body.

Here, the through-holes may each have a circular or elliptical shape. Particularly, the through-holes may be regularly arranged such that distances between the centers thereof are constant.

Further, the hollow cylindrical body may include at least one groove formed in one of outer and inner circumferences thereof in a lengthwise direction thereof.

According to another aspect of the present invention, there is provided a porous plenum spacer for a dual-cooled fuel rod, in which the porous plenum spacer is inserted into a plenum of the dual-cooled fuel rod having concentric inner and outer cladding tubes. The porous plenum spacer comprises: a hollow cylindrical body inserted into an annular space between the inner and outer cladding tubes; and at least one groove formed in one of outer and inner circumferences of the hollow cylindrical body in a lengthwise direction of the hollow cylindrical body.

Here, the grooves may be formed such that intervals therebetween are equal to each other.

According to yet another aspect of the present invention, there is provided a porous plenum spacer for a dual-cooled fuel rod, in which the porous plenum spacer and a plenum spring are inserted into a plenum of the dual-cooled fuel rod having concentric inner and outer cladding tubes. The porous plenum spacer comprises: a hollow cylindrical body inserted into an annular space between the inner and outer cladding tubes; and a plurality of through-holes formed in an outer circumference of the hollow cylindrical body. The porous plenum spacer has a length gotten by subtracting the length of the plenum spring from the previously determined length of the plenum. The plenum spring includes a coil spring having an effective number of spring coils and satisfying the formula below:

$$N = \frac{G}{8 \cdot {D}^{3} \cdot K} \cdot {d}^{4}$$

where G is the shear modulus, D is the average diameter of the spring, K is the spring constant, and d is the diameter of the spring wire.

Here, the diameter of the spring wire of the plenum spring may have a maximum value corresponding to a width of a gap between the inner and outer cladding tubes.

Further, the through-holes may each have a circular or elliptical shape. Particularly, the through-holes may be regularly arranged such that distances between the centers thereof are constant.

Also, the hollow cylindrical body may include at least one groove formed in one of outer and inner circumferences thereof in a lengthwise direction.

According to still yet another aspect of the present invention, there is provided a porous plenum spacer for a dual-cooled fuel rod, in which the porous plenum spacer and a plenum spring are inserted into a plenum of the dual-cooled fuel rod having concentric inner and outer cladding tubes. The porous plenum spacer comprises: a hollow cylindrical body inserted into an annular space between the inner and outer cladding tubes; and a combination of at least one selected from a first unit spacer that has a plurality of through-holes formed in an outer circumference of a hollow cylindrical body thereof, a second unit spacer that has at least one groove formed in one of outer and inner circumferences of the hollow cylindrical body of the first unit spacer in a lengthwise direction, and a third unit spacer that has at least one groove in the outer or inner circumference of a hollow cylindrical body thereof in a lengthwise direction. The combination of the unit spacers has an overall length gotten by subtracting the length of the plenum spring from the previously determined length of the plenum. The plenum spring includes a coil spring having an effective number of spring coils and satisfying the formula below:

$$N = \frac{G}{8 \cdot {D}^{3} \cdot K} \cdot {d}^{4}$$

where G is the shear modulus, D is the average diameter of the spring, K is the spring constant, and d is the diameter of the spring wire.

Here, the diameter of the spring wire of the plenum spring may have a maximum value corresponding to a width of a gap between the inner and outer cladding tubes.

Further, the through-holes may be regularly arranged such that distances between the centers thereof are constant, and the grooves may be formed such that intervals therebetween are equal to each other.

According to embodiments of the present invention, the porous plenum spacer for the dual-cooled fuel rod can simplify a shape of the plenum spring and be easily manufactured to effectively enhance economic efficiency because the coil-type plenum spring applied to an existing fuel rod is adapted to maintain its basic shape and to vary only in size.

Further, the porous plenum spacer can secure a sufficient plenum while satisfying structural compatibility with an existing fuel rod, so that it can sufficiently contain fission gas inevitably generated in the combustion process, and thus be applied to a high burnup nuclear fuel (annular pellet). This porous plenum spacer can serve to sufficiently reduce the technical burden of commercializing dual-cooled nuclear fuel.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a schematic front view illustrating a conventional cylindrical nuclear fuel assembly;

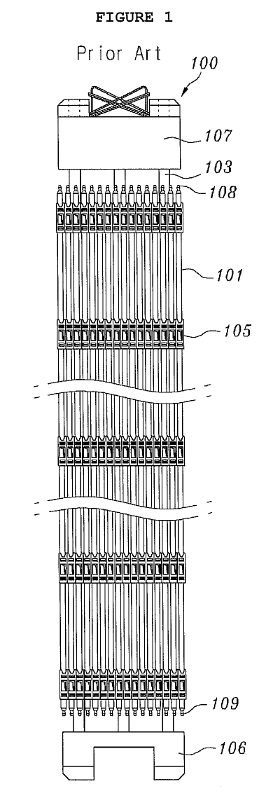

FIG. 2A is a schematic cross-sectional view illustrating a plenum spring for a conventional cylindrical fuel rod;

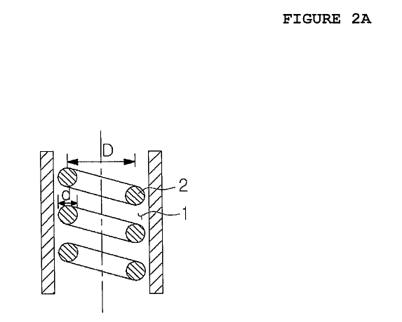

FIG. 2B is a schematic cross-sectional view illustrating a plenum spring for a dual-cooled fuel rod;

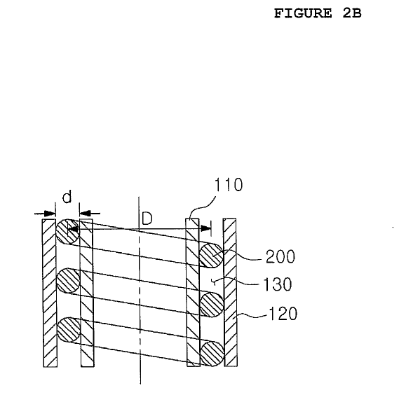

FIG. 3 is a schematic cross-sectional view illustrating a plenum spring and a spacer for a conventional cylindrical fuel rod;

FIG. 4 is a schematic cross-sectional view illustrating a structure of a plenum spring and a porous plenum spacer in the case where a length of the plenum of FIG. 3 is maintained without change in accordance with an exemplary embodiment of the present invention;

FIG. 5 is a front view illustrating a porous plenum spacer according to an exemplary embodiment of the present invention;

FIG. 6 is a front view illustrating a porous plenum spacer according to another exemplary embodiment of the present invention;

FIG. 7 is a front view illustrating a porous plenum spacer according to yet another exemplary embodiment of the present invention;

FIG. 8 is a perspective view illustrating a first unit spacer according to the present invention;

FIG. 9 is a perspective view illustrating a second unit spacer according to the present invention; and

FIG. 10 is a perspective view illustrating a third unit spacer according to the present invention.

### DETAILED DESCRIPTION OF THE INVENTION

Reference will now be made in greater detail to a porous plenum spacer for a dual-cooled fuel rod according to exemplary embodiments of the invention with reference to the accompanying drawings.

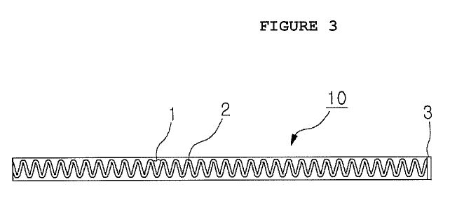

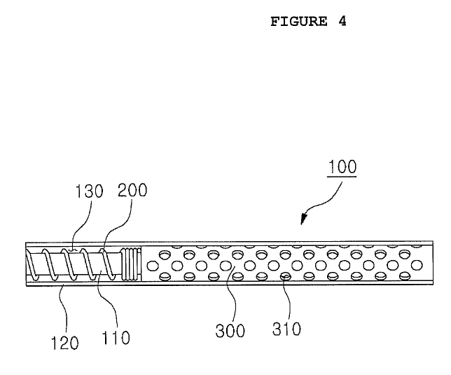

As illustrated in FIG. 4, a plenum spring 200 inserted into an annular plenum of a dual-cooled fuel rod 100 is considerably shortened compared to the conventional plenum spring 2 illustrated in FIG. 3. Thus, according to an exemplary embodiment of the present invention, a plenum spacer 300 for the dual-cooled fuel rod has the following construction to secure a space containing fission gas inevitably generated by a nuclear reaction.

The porous plenum spacer 300 for the dual-cooled fuel rod is a spacer that is inserted into a plenum 300 of the dual-cooled fuel rod 100 having concentric inner and outer cladding tubes 110 and 120. The plenum spacer 300 includes a hollow cylindrical body that can be inserted into an annular space between the inner and outer cladding tubes 110 and 120. The body is provided with a plurality of through-holes 310 in an outer circumference thereof. In other words, a space defined by the through-holes 310 serves to contain the fission gas.

The through-holes 310 may each have various shapes including circular or elliptical shapes, and most preferably the circular shape when taking into consideration easy machining and arrangement thereof. From the standpoint of local strength of the porous plenum spacer 300, the through-holes 310 may as well be regularly arranged such that distances between the centers thereof are constant.

An entire strength of the porous plenum spacer 300 will be greatly affected depending on the percentage of the volume that the pores formed by the through-holes 310 accounts for in the volume of the porous plenum spacer 300. Consequently, the number, shape, size, arrangement, etc. of the through-holes 310 must be optimized so as to have a structure capable of sufficiently covering stress caused by the degree of deformation of the plenum spring 200. However, since the present invention is directed to proposing a basic structure of the porous plenum spacer 300 for the dual-cooled fuel rod, details of such optimization will be disclosed through another invention in future.

In addition to the construction of the through-holes 310, the body of the porous plenum spacer 300 may be provided with at least one groove 320 in an outer or inner circumference thereof in a lengthwise direction thereof. Since the groove 320 does not pass through the body of the porous plenum spacer 300, a proper combination of the through-holes 310 and the groove 320 is allowed to secure sufficient pores and maintain the strength of the porous plenum spacer 300. In other words, due to the construction of the groove 320, the degree of freedom of the design of the porous plenum spacer 300 is enhanced.

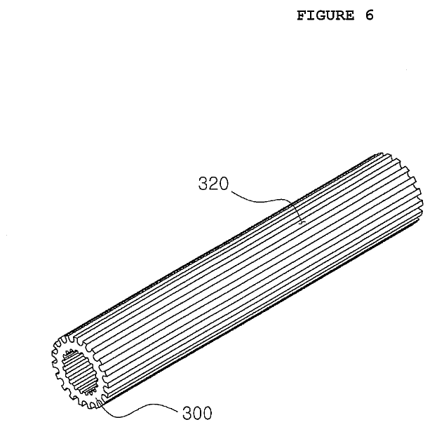

Of course, if called for by the aspect of the design, it is possible to omit the construction of the through-holes 310, and make the porous plenum spacer 300 in which only the groove 320 (see FIG. 6) is constructed. In this embodiment of the present invention, a plurality of grooves 320 may be formed. In this case, the grooves 320 are preferably formed to be separated by the same interval.

Further, the dual-cooled fuel rod 100 composed the concentric inner and outer cladding tubes 110 and 120 includes the plenum spring 200 and the porous plenum spacer 300 inserted into the plenum 130 thereof.

The plenum spring 200 is a coil spring having an effective number N of spring coils which satisfies the following formula. Here, the diameter d of a spring wire of the plenum spring 200 has a maximum value limited to the width of a gap between the inner and outer cladding tubes 110 and 120.

$$N = \frac{G}{8 \cdot {D}^{3} \cdot K} \cdot {d}^{4}$$

where G is the shear modulus, D is the average diameter of the spring, K is the spring constant, and d is the diameter of the spring wire.

Further, the length of the plenum spring 200 must be restricted within such a range that an excessive contact does not occur between an inner surface of the outer cladding tube 120 and the plenum spring even if the average diameter of the plenum spring 200 is increased by compression of the plenum spring 200. In other words, it is actually impossible to use the plenum spring 220, the length of which is too long compared to the effective number of spring coils thereof.

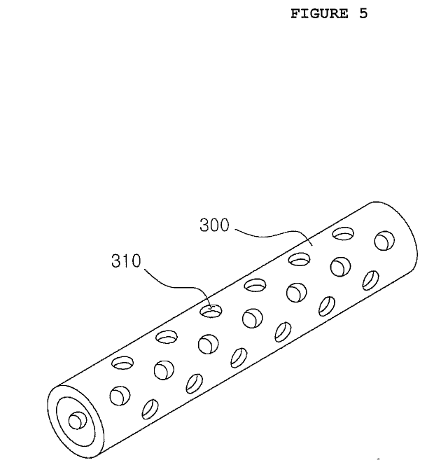

As described above, the porous plenum spacer 300 has the hollow cylindrical body that can be inserted into the annular space between the inner and outer cladding tubes 110 and 120. Further, the numerous through-holes 310 may be formed in the outer circumference of the body (see FIG. 5). Alternatively, one or more grooves 320 may be formed in the outer or inner circumference of the body in a lengthwise direction of the body (see FIG. 6).

Here, the length of the porous plenum spacer 300 has the length gotten by subtracting the length of the plenum spring 200 from the length of the plenum 130. In other words, this embodiment is characterized in that the porous plenum spacer 300 is an integral unit.

The through-holes 310 may each have a circular or elliptical shape, and may be regularly arranged such that the distances between the centers thereof are constant.

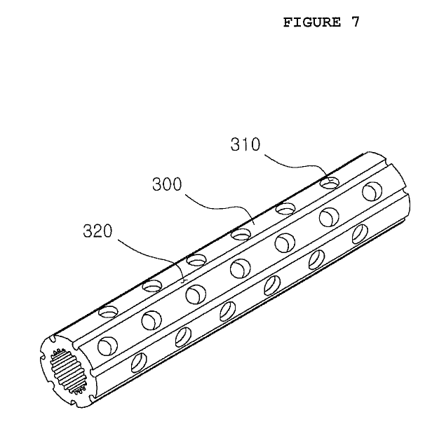

Further, as illustrated in FIG. 7, the porous plenum spacer 300 having the through-holes 310 may have one or more grooves 320 in the outer or inner circumference of the body thereof in a lengthwise direction of the body. In other words, the porous plenum spacer 300 is a spacer in which the through-holes 310 and the grooves 320 are used in combination.

Another embodiment of the present invention is characterized in that a plurality of unit spacers 400, 500 and 600 having a short length are combined instead of the integrated porous plenum spacer 300. This is because, in the case where the spacer is made of a ceramic material of Al₂O₃, there is a possibility of causing a problem with machinability when the length of the spacer becomes long.

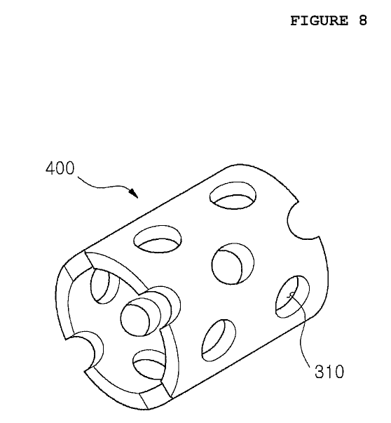

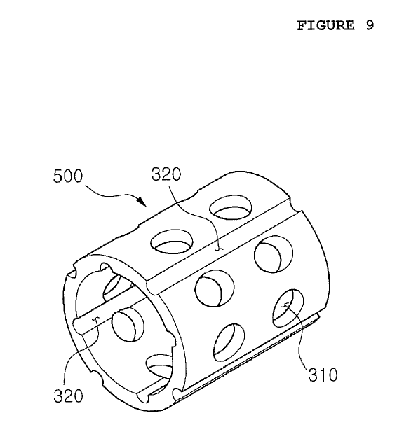

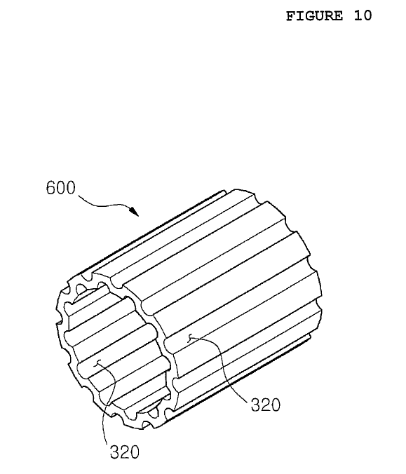

Three types of unit spacers 400, 500 and 600 are provided: a first unit spacer 400 having a plurality of through-holes 310 in the outer circumference of a body thereof, a second unit spacer 500 having one or more grooves 320 in the outer or inner circumference of the body of the first unit spacer 400 in a lengthwise direction thereof, and a third unit spacer 600 having one or more grooves 320 in the outer or inner circumference of a body thereof in a lengthwise direction. When one spacer is configured using the numerous first, second and third unit spacers 400, 500 and 600, only one type of unit spacer may be used, and two or three types of unit spacers may be combined and used. The shapes of the first, second and third unit spacers 400, 500 and 600 are illustrated in FIGS. 8, 9 and 10, respectively.

The through-holes 310 formed in the first and second unit spacers 400 and 500 are regularly arranged such that distances between the centers thereof are constant. In the case where the grooves 320 formed in the second and third spacers 500 and 600 are plural in number, it is preferable that the grooves 320 are formed at the same interval.

Here, the maximum value of the diameter d of a spring wire of the plenum spring 200 is the length of the gap between the inner and outer cladding tubes 110 and 120. An overall length of the combined unit spacers has a length subtracting the length of the plenum spring 200 from the previously determined length of the plenum 130, which is the same as in the integrated porous plenum spacer 300.

Although exemplary embodiments of the present invention have been described for illustrative purposes, those skilled in the art will appreciate that various modifications, additions and substitutions are possible, without departing from the scope and spirit of the invention as disclosed in the accompanying claims.

1. A porous plenum spacer for a dual-cooled fuel rod, in which the porous plenum spacer is inserted into a plenum of the dual-cooled fuel rod having concentric inner and outer cladding tubes, the porous plenum spacer comprising:
a hollow cylindrical body inserted into an annular space between the inner and outer cladding tubes; and
a plurality of through-holes formed in an outer circumference of the hollow cylindrical body.

2. The porous plenum spacer as set forth in claim 1, wherein the through-holes each have a circular or elliptical shape.

3. The porous plenum spacer as set forth in claim 1, wherein the through-holes are regularly arranged such that distances between centers thereof are constant.

4. The porous plenum spacer as set forth in claim 1, wherein the hollow cylindrical body includes at least one groove formed in one of outer and inner circumferences thereof in a lengthwise direction.

5. A porous plenum spacer for a dual-cooled fuel rod, in which the porous plenum spacer is inserted into a plenum of the dual-cooled fuel rod having concentric inner and outer cladding tubes, the porous plenum spacer comprising:
a hollow cylindrical body inserted into an annular space between the inner and outer cladding tubes; and
at least one groove formed in one of outer and inner circumferences of the hollow cylindrical body in a lengthwise direction of the hollow cylindrical body.

6. The porous plenum spacer as set forth in claim 5, wherein the grooves are formed such that intervals therebetween are equal to each other.

7. A porous plenum spacer for a dual-cooled fuel rod, in which the porous plenum spacer and a plenum spring are inserted into a plenum of the dual-cooled fuel rod having concentric inner and outer cladding tubes, the porous plenum spacer comprising:
a hollow cylindrical body inserted into an annular space between the inner and outer cladding tubes; and
a plurality of through-holes formed in an outer circumference of the hollow cylindrical body,
wherein the porous plenum spacer has a length subtracting a length of the plenum spring from a previously determined length of the plenum, and
the plenum spring includes a coil spring having an effective number N of spring coils and satisfying a formula below:
$$N = \frac{G}{8 \cdot {D}^{3} \cdot K} \cdot {d}^{4}$$
where G is the shear modulus, D is the average diameter of the spring, K is the spring constant, and d is the diameter of the spring wire.

8. A porous plenum spacer for a dual-cooled fuel rod, in which the porous plenum spacer and a plenum spring are inserted into a plenum of the dual-cooled fuel rod having concentric inner and outer cladding tubes, the porous plenum spacer comprising:
a hollow cylindrical body inserted into an annular space between the inner and outer cladding tubes; and
at least one groove formed in one of outer and inner circumferences of the hollow cylindrical body in a lengthwise direction of the hollow cylindrical body,
wherein the porous plenum spacer has a length gotten by subtracting a length of the plenum spring from a previously determined length of the plenum, and
the plenum spring includes a coil spring having an effective number N of spring coils and satisfying a formula below:
$$N = \frac{G}{8 \cdot {D}^{3} \cdot K} \cdot {d}^{4}$$
where G is the shear modulus, D is the average diameter of the spring, K is the spring constant, and d is the diameter of the spring wire.

9. The porous plenum spacer as set forth in claim 7, wherein the diameter of the spring wire of the plenum spring has a maximum value corresponding to a width of a gap between the inner and outer cladding tubes.

10. The porous plenum spacer as set forth in claim 7, wherein the through-holes each have a circular or elliptical shape.

11. The porous plenum spacer as set forth in claim 7, wherein the through-holes are regularly arranged such that distances between centers thereof are constant.

12. The porous plenum spacer as set forth in claim 7, wherein the hollow cylindrical body includes at least one groove formed in one of outer and inner circumferences thereof in a lengthwise direction.

13. A porous plenum spacer for a dual-cooled fuel rod, in which the porous plenum spacer and a plenum spring are inserted into a plenum of the dual-cooled fuel rod having concentric inner and outer cladding tubes, the porous plenum spacer comprising:
a hollow cylindrical body inserted into an annular space between the inner and outer cladding tubes; and
a combination of at least one selected from a first unit spacer that has a plurality of through-holes formed in an outer circumference of a hollow cylindrical body thereof, a second unit spacer that has at least one groove formed in one of outer and inner circumferences of the hollow cylindrical body of the first unit spacer in a lengthwise direction, and a third unit spacer that has at least one groove in the outer or inner circumference of a hollow cylindrical body thereof in a lengthwise direction,
wherein an overall length of the combination of the unit spacers is gotten by subtracting a length of the plenum spring from a previously determined length of the plenum, and
the plenum spring includes a coil spring having an effective number N of spring coils and satisfying a formula below:
$$N = \frac{G}{8 \cdot {D}^{3} \cdot K} \cdot {d}^{4}$$
where G is the shear modulus, D is the average diameter of the spring, K is the spring constant, and d is the diameter of the spring wire.

14. The porous plenum spacer as set forth in claim 13, wherein the diameter of the spring wire of the plenum spring has a maximum value corresponding to a width of a gap between the inner and outer cladding tubes.

15. The porous plenum spacer as set forth in claim 13, wherein the through-holes are regularly arranged such that distances between centers thereof are constant, and the grooves are formed such that intervals therebetween are equal to each other.
